(19) United States
(12) Patent Application Publication
(10) Pub. No.: US 2004/0208584 A1
(43) Pub. Date: Oct. 21, 2004

(54) Reconfigurable optical add-drop multiplexer using an analog mirror device

(76) Inventor: Robert C. Keller, Plano, TX (US)

Correspondence Address: TEXAS INSTRUMENTS INCORPORATED, P O BOX 655474, M/S 3999, DALLAS, TX, 75265

(21) Appl. No.: 10/060,666

(22) Filed: Jan. 29, 2002

(51) Int. Cl. G02B 6/28; H04J 14/02

(52) U.S. Cl. 398/88; 385/24

(57) ABSTRACT

An optical add-drop multiplexer 400 includes an optical demultiplexer 410 having an input port coupled to receive an wavelength multiplexed optical signal. The optical demultiplexer 410 has a plurality of outputs, each for carrying an optical signal at one of the plurality of wavelengths. Switch optics 440 includes a channel coupled to each output. Each channel of the switch optics includes an analog mirror 424 coupled to receive the optical signal for that channel. The analog mirror 424 is rotatable along at least one axis is able to reflect a received optical signal in more than two directions. Each channel also includes an in/out lens device 422 aligned to receive the optical signal from the analog mirror 424 in a pass mode and an add/drop lens device 426 aligned to receive the optical signal from the analog mirror device 424 in an add/drop mode.

### FIELD OF THE INVENTION

This invention relates generally to communication systems, and more particularly to a reconfigurable optical add-drop multiplexer using an analog mirror device.

### BACKGROUND OF THE INVENTION

One of the goals of communications systems is to route more and more information from one place to another. For example, networks that once carried only voice signals are now being asked to carry voice, data and video. Similarly, networks that were initially designed for data transport must now carry voice and video. The explosion of communications need has created a need to develop systems that have a greater bandwidth.

One of the developments in this area has been the development of dense wavelength division multiplexed (DWDM) systems. Whereas networks in the past carried optical signals at a single wavelength, networks are now being asked to carry signals at many different wavelengths along a single fiber. One of the goals is to move these signals throughout the network in the optical domain.

A very simplified diagram of a DWDM network 100 is shown in FIG. 1. This network includes four nodes, labeled 102-108, configured in a ring. Real-world networks are likely to include many more nodes. Node 102 has been labeled as a hub. In this example, a DWDM signal enters the ring at the port labeled IN. The signal circulates from node 102 clockwise around the ring to each of the other nodes.

Nodes 104, 106 and 108 are drawn as optical add-drop multiplexers (OADM). At each of these nodes, a DWDM signal enters the node and a second DWDM signal leaves the node. The difference between the signal that enters and the signal that leaves is that signals at certain wavelengths can be exchanged with other signals at that same wavelength. This is shown by the ports labeled Add and Drop at each node. A signal carried at a wavelength that is dropped may (or may not) be replaced by another signal carried at that same wavelength. Similarly, a signal at a wavelength not already being used can be added to the ring.

FIG. 2 shows an example of a known OADM 200. This figure is similar to that available at www.santec.com/productinfo/ioadm.htm (January 2002). A WDM signal enters OADM 200 at a port labeled IN and is provided to a demultiplexer 202.

Demultiplexer 202 outputs a number of single wavelength signals on lines 204. In the illustrated example, four wavelengths were multiplexed in the WDM signal.

Each of the signals on lines 204 is provided to a 2×2 switch 206. The 2×2 switch 106 operates in the optical domain to either pass the signal through to optical variable attenuator (OVA) 208 or to the drop port 210. If the 2×2 switch 206 is set to pass the input signal to the drop port (or no input signal exists at that wavelength), a new signal can be added through add port 212. This newly added signal will be passed to respective OVA 208.

The purpose of OVA 208 is to attenuate certain ones of the signals from the switches 206 so that the amplitude of each signal is substantially the same. This is done so that when the signals are combined and amplified, no one of the signals takes most of the amplifier power.

Signals from the OVAs 208 are provided to photodetectors 214. The purpose of the photodetectors is to measure the power of each wavelength after passing through the OVAs, thereby allowing the OVA to be adjusted to set a specific output power.

Finally, the separate wavelength signals are combined in multiplexer 216. As shown, multiplexer 216 includes a number (four in the case) of input ports 218 and a single output port OUT, which carries a DWDM signal. The OADM 200 can be used for any of the nodes 104, 106 or 108 in FIG. 1.

Another design OADM is discussed by Ford et al. in “Wavelength Add-Drop Switching Using Tilting Micromirror,” Journal of Lightwave Technology, Vol. 17, No. 5, May 1999, pp. 904-911. See also U.S. Pat. No. 6,204,946, which along with the Ford paper, is incorporated herein by reference. FIGS. 3a-3c illustrate an OADM 300 as described in the Ford paper. This technique uses surface-normal operation of microoptomechanical switch arrays with free-space optical interconnection to single node fiber inputs and outputs.

Referring first to FIG. 3a, and as described in the paper, the OADM 300 shows four WDM fiber ports, labeled In, Out, Add and Drop. The input port In is connected through an optical circulator 302 to a wavelength demultiplexer 304 and then to a set of 1×1 switches 306, each of which can reflect or transmit one wavelength channel. Reflected signals retrace their path through the wavelength multiplexer 304 and into the circulator 302, which separates the back-reflected light into the output node Out.

Transmitted signals are collected by a separate wavelength multiplexer 308 and directed into the second port of a second optical circulator 310 to the Drop output. The Add port, connected to the first input of the second optical circulator, brings in new data by retracing the same optical path created by dropping the input channels.

FIGS. 3b and 3c show the geometry of a wavelength add-drop switch 306 as taught by Ford et al. An input signal is imaged onto a tilt mirror 320 so that in one switch state the signal is back reflected (FIG. 3b) and in the other switch state the signal is tilted to reflect the input toward the Add signal source, so that the original input and add signals are counter-propagating. The switch 320 is never required to route light from the Add to Drop ports. If a switch element 320 set to pass the signal from In to Out is illuminated from the “add” source, the reflected light is tilted away from both the Out and Drop ports (a path not shown in either FIG. 3a or 3b). Referring to FIG. 3a, each element in a linear array of such switches 306 is illuminated by a single wavelength picked out of the WDM fiber transmission.

### SUMMARY OF THE INVENTION

In one aspect, the present invention provides an optical add-drop multiplexer that includes only one mirror per channel (e.g., per wavelength). The present invention also includes embodiments that add the capability to switch between fibers if a fiber break occurs. Further, the present invention includes embodiments that provide the ability to variably attenuate each wavelength signal.

In a first embodiment, an optical add-drop multiplexer includes an optical demultiplexer having an input port coupled to receive an input optical signal carrying information at a plurality of wavelengths, e.g., a DWDM signal. The optical demultiplexer has a plurality of outputs, each for carrying an optical signal at one of the plurality of wavelengths. Switch optics includes a channel coupled to each output. Each channel of the switch optics includes an analog mirror device coupled to receive the optical signal for that channel. The analog mirror is rotatable along at least one axis is able to reflect a received optical signal in more than two directions. Each channel also includes an in/out lens device aligned to receive the optical signal from the analog mirror device when said analog mirror device is in a pass mode and an add/drop lens device aligned to receive the optical signal from the analog mirror device when the analog mirror device is in an add/drop mode.

In some embodiments, the analog mirror can be controlled so that the attenuation of a signal passing through the in/out lens can be varied by varying the alignment between the in/out lens and the analog mirror. Tilting the mirror surface of the analog mirror so that it is not perfectly aligned with the lens typically effects this control. In this manner, some of the optical power will miss the lens and, as a result, the signal will be attenuated. This attenuation can be controlled so as to be at the desired level.

### BRIEF DESCRIPTIONS OF THE DRAWINGS

The above features of the present invention will be more clearly understood from consideration of the following descriptions in connection with accompanying drawings in which:

FIG. 1 shows a known ring network topology;

FIG. 2 shows known optical add-drop multiplexer;

FIGS. 3a-3b show a second known optical add-drop multiplexer;

FIG. 4 shows a first embodiment optical add-drop multiplexer of the present invention;

FIG. 5 is a plan view of an analog mirror device that can be used with various embodiments of the present invention;

FIG. 5a is a cross sectional view taken on line 5A-5A of FIG. 5;

FIG. 5b is a view similar to FIG. 5a but showing rotation of the mirror portion of the mirror assembly;

FIG. 5c is a cross sectional view taken on line 5B-5B of FIG. 5;

FIG. 5d is a view similar to FIG. 5c but showing rotations of the gimbals portion of the mirror assembly;

FIGS. 6a-6b and FIGS. 7a-7b show two switch states of an OADM of FIG. 4;

FIGS. 8a and 8b show the relationship between output power and tilt angle for an analog mirror used as taught by aspects of the present invention;

FIG. 9 shows an alternate embodiment optical add-drop multiplexer of the present invention;

FIG. 10 shows yet another embodiment optical add-drop multiplexer of the present invention;

FIGS. 11a-11b through 16a-16b show various switch states of an OADM of FIG. 10; and

FIGS. 12a and 12b are diagrams illustrating a power control algorithm.

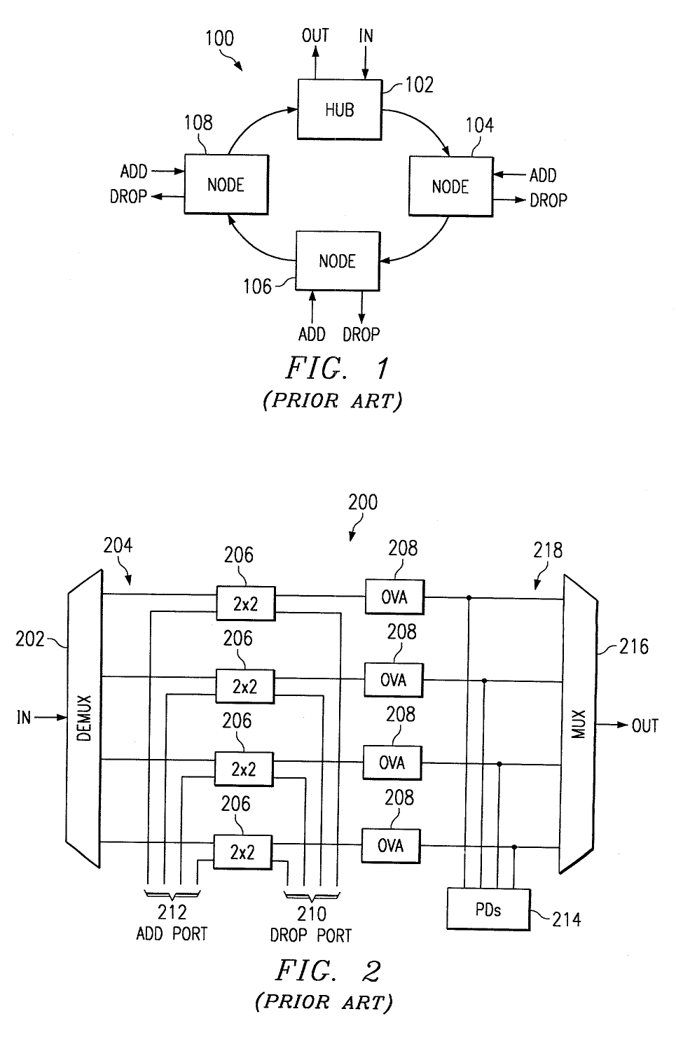

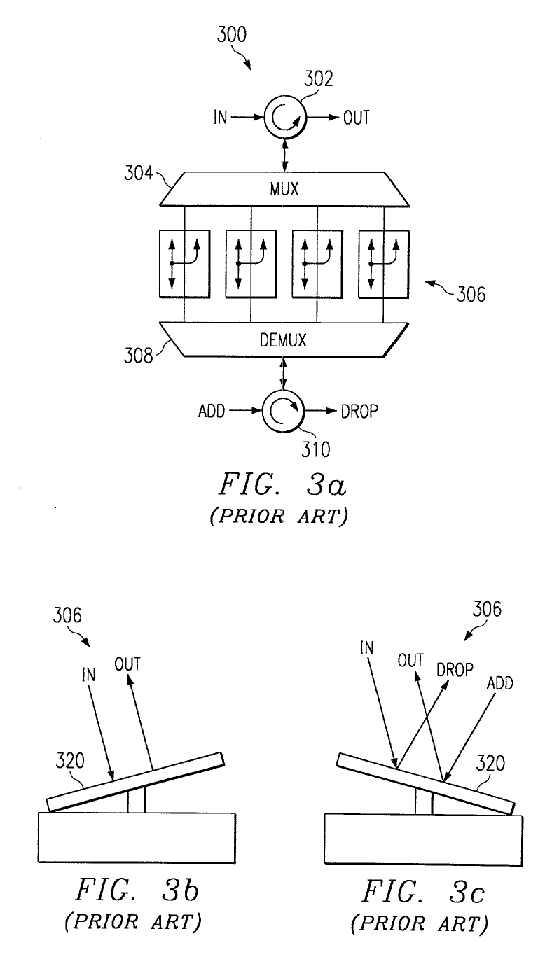

### DETAILED DESCRIPTION OF A PREFERRED EMBODIMENT

The making and use of the various embodiments are discussed below in detail. However, it should be appreciated that the present invention provides many applicable inventive concepts that can be embodied in a wide variety of specific contexts. The specific embodiments discussed are merely illustrative of specific ways to make and use the invention, and do not limit the scope of the invention.

The present invention incorporates a number of aspects, which will be described with respect to FIGS. 4-16. Various ones of these embodiments can be implemented together or independently.

Referring first to FIG. 4, a first embodiment optical add-drop multiplexer (OADM) 40 is illustrated. This embodiment OADM includes a single input/output and add/drop port for each channel.

A wavelength division multiplexed (WDM) signal, for example a dense WDM (DWDM) signal, is provided to port one of a circulator 402. The port one can also be referred to as input port 404. As is known in the art, a three-port optical circulator is a device that transfers an input signal at the first port 404 to the second port 406 and also transfers a signal received at the second port 406 to the third port 408. The third port 408 can also be referred to as output port 408. An example of a commercially available circulator is the Thorlabs 6015-3-FC/APC. The WDM signal is provided from second port 406 to optical multiplexer/demultiplexer 410. Other components, not illustrated for the sake of simplicity, could be included between circulator 402 and optical multiplexer/demultiplexer 410.

Optical multiplexer/demultiplexer 410 operates as a bi-directional device that takes a single signal that includes a number of channels at different wavelengths and separates each of these channels into separate optical signals at lines 412. In the preferred embodiment, each separate signal carries only one wavelength but other embodiments are envisioned where the separate signals may themselves be WDM signals. The multiplexer/demultiplexer 410 is symmetric in that it will also take separate signals at lines 412 and combine them into a WDM signal. An example of a commercially available multiplexer/demultiplexer 410 is available from APA Optics

In an another embodiment, the the demultiplexing and multiplexing functions can be performed in free space, for example using a grating, prism, and filters. In this embodiment, each wavelength has a separate optical path to and from a mirror. This technique is similar to that used in the Ford et al. paper, which was discussed in the background and is incorporated herein by reference.

In the preferred embodiment, each channel of the system is provided to a subsystem switch 414. FIG. 4 only illustrates a single subsystem switch 414 coupled to a channel carrying a first wavelength signal labeled at λ₁. In the preferred embodiment, an identical switch 414 is provided for each wavelength signal. In other embodiments, some of the channels could be passed without a switch or by using a different design switch.

Discussion will now proceed with respect to the first wavelength signal λ₁, but it is understood that a similar discussion would apply to any channel that includes a switch 414.

First wavelength signal λ₁ is optionally provided to a bi-directional tap 416. The bi-directional tap redirects a portion of the first wavelength signal λ₁ to input detector 418 or output detector 420, depending upon the direction that the signal is traveling. (In operation, signals are typically traveling in both directions simultaneously.) As an example, the bi-directional tap 416 can be a 1% bi-directional tap such as is available from Fiberdyne Labs (part no. FCC-02X-001-031). In a 1% bi-directional tap, 99% of the optical power is passed while 1% of the optical power is diverted to the detectors 418 or 420.

As will be discussed in greater detail below, the input and output detectors 418 and 420 can be used in embodiments where the optical intensity of signals passing through the switch 414 is being controlled. When such control is not being implemented, the input and output detectors are not needed. First wavelength signal λ₁ travels from bi-directional tap 416 to a lens device 422. In the preferred embodiment, lens device 422 is a GRIN (gradient index) lens. A commercially available GRIN lens assembly is available from CASIX (JDSU) FIGA22120M. The GRIN lens assembly contains a GRIN lens aligned to a fiber optic with a standard fiber optic connector on the other end of the fiber. This connector can be used to connect to the demultiplexer/multiplexer. The GRIN lens 422 will collimate first wavelength signal λ₁ and direct the signal to analog mirror 424. It is noted that all the optics should be aligned to the center of rotation of the analog mirror to avoid excess loss of light in the switch. Other types of lens devices, such as spherical or aspherical lenses, could alternatively be used.

Analog mirror device 424 is movable in an analog fashion, preferably along two axes. An example of such an analog mirror device is shown in U.S. Pat. No. 6,295,154, which is incorporated herein by reference. The analog mirror device 422 includes a mirror surface that can tilt in an analog fashion. Light can be reflected in any angle out of a square cone. At present, the mechanical deflection angle of the mirror can be controlled within a range of about plus or minus five degrees to a resolution of about 1/1000^{th} of a degree.

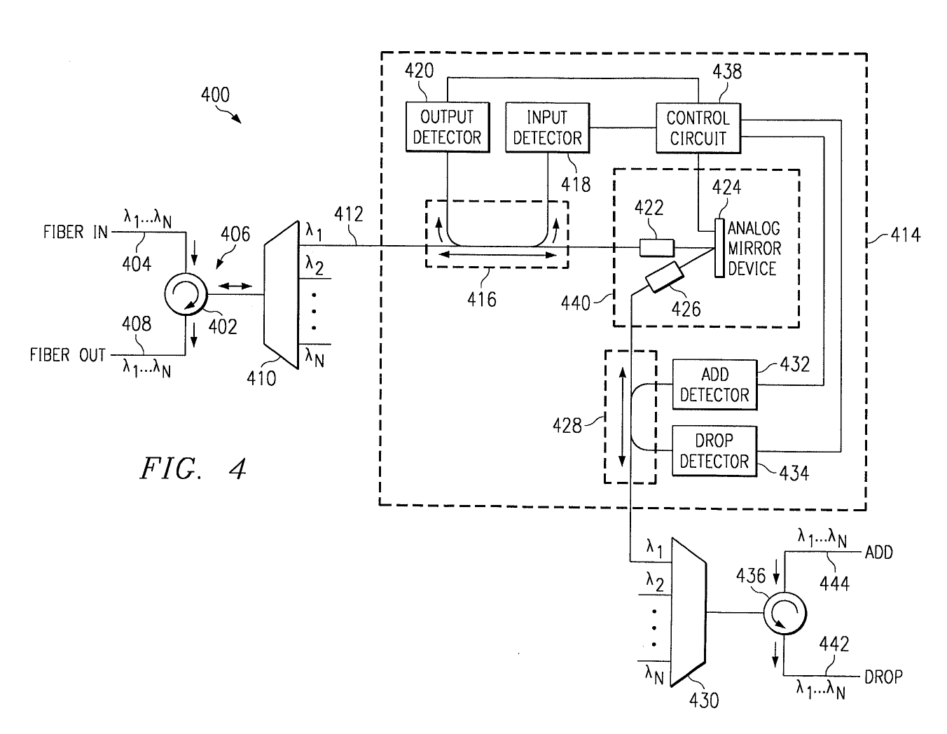

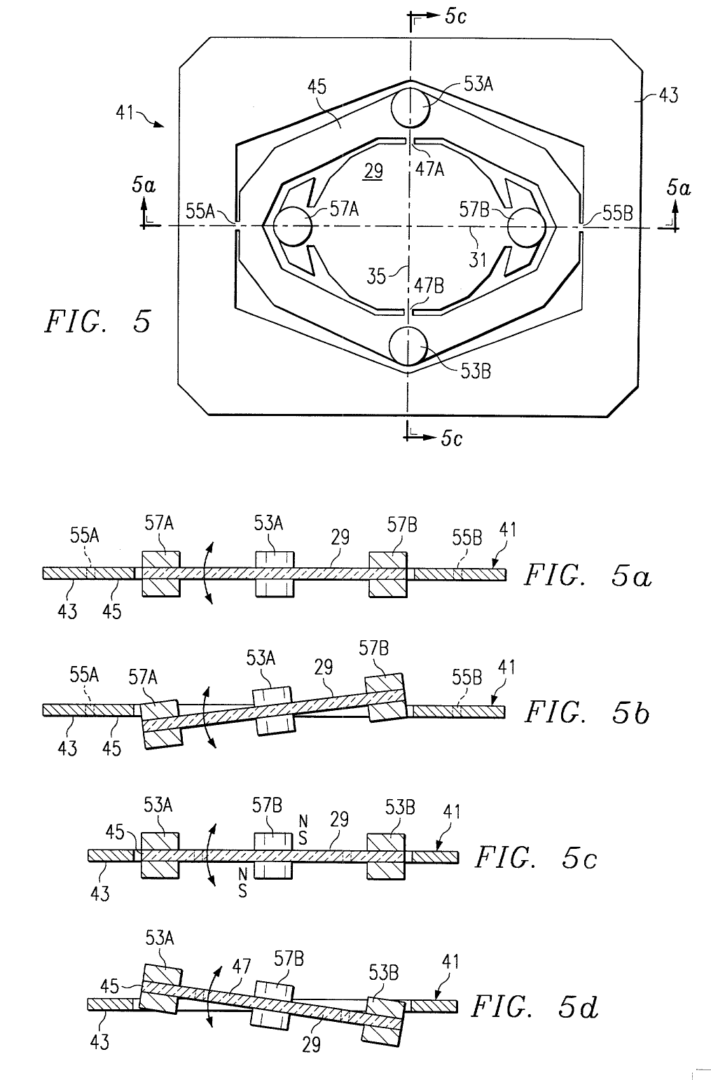

FIG. 5 illustrates an example of an analog mirror device. Further detail one implementation of an analog mirror device can be found in U.S. Pat. No. 6,295,154, incorporated herein by reference.

As shown in FIG. 5, mirror assembly 41 includes a frame portion, an intermediate gimbals portion and an inner mirror portion preferably formed from one piece of crystal material such as silicon. The silicon is etched to provide outer frame portion 43 forming an opening in which intermediate annular gimbals portion 45 are attached at opposing hinge locations 55a and 55b along first axis 31.

An inner, centrally disposed mirror portion 29, having a mirror centrally located thereon, is attached to gimbals portion 45 at hinge portions 47a and 47b on a second axis 35, ninety degrees from the first axis. The mirror 29, which is typically on the order of about 100 microns in thickness, is suitably polished on its upper surface to provide a specular surface or mirror surface. In order to provide necessary flatness, the mirror is formed with a radius of curvature greater than approximately 2 meters, with increasing optical path lengths requiring increasing radius of curvature. The radius of curvature can be controlled by known stress control techniques such as, by polishing on both opposite faces and deposition techniques for stress controlled thin films. If desired, a coating of suitable material can be placed on the mirror portion to enhance its reflectivity for specific radiation wavelengths.

Mirror assembly 41 also includes a first pair of permanent magnets 53a and 53b mounted on gimbals portion 45 along the second axis and a second pair of permanent magnets 57a and 57b is mounted on extensions 51, which extend outwardly from mirror portion 47 along the first axis. In order to symmetrically distribute mass about the two axes of rotation to thereby minimize oscillation under shock and vibration, each permanent magnet 53a, 53b, 57a and 57b preferably comprises a set of an upper magnet mounted on the top surface of the mirror assembly 41 using conventional attachment techniques such as indium bonding, and an aligned lower magnet 53b similarly attached to the lower surface of the mirror assembly as shown in FIGS. 5a-5d. The magnets of each set are arranged serially such as the north/south pole arrangement indicated in FIG. 5c. There are several possible arrangements of the four sets of magnets which may be used, such as all like poles up, or two sets of like poles up, two sets of like poles down; or three sets of like poles up, one set of like pole down, depending upon magnetic characteristics desired.

By mounting gimbals portion 45 to frame portion 43 by means of hinges 55a and 55b, motion of the gimbals portion 45 about the first axis 31 is provided and by mounting mirror portion 29 to gimbals portion 45 via hinges 47a and 47b, motion of the mirror portion relative to the gimbals portion is obtained about the second axis 35, thereby allowing independent, selected movement of the mirror portion 47 along two different axes.

The middle or neutral position of mirror assembly 41 is shown in FIG. 5a, which is a section taken through the assembly along line 5A-5A of FIG. 5. Rotation of mirror portion 29 about axis 35 independent of gimbals portion 45 and/or frame portion 43 is shown in FIG. 5b as indicated by the arrow. FIG. 5c shows the middle position of the mirror assembly 41, similar to that shown in FIG. 5a, but taken along line 5B-5B of FIG. 5. Rotation of the gimbals portion 45 and mirror portion 47 about axis 31 independent of frame portion 43 is shown in FIG. 5d as indicated by the arrow. The above independent rotation of mirror of mirror portion 29 about the two axes allows direction of optical beam 13 as needed by the optical switch units. In order to protect the torsional hinges 47a, 47b, 55a and 55b from in-plane shock during handling and shipping, stops may be provided as an optional feature of the invention. At this point, it should be noted that the mirror assembly is on the order of 100 microns thick, whereas the hinges of the same thickness are on the order of 10 microns wide, thereby providing robust strength in directions normal to the surface of the assembly. In order to provide protection against excess in-plane motion 90° to the axis of the hinge, for example, axis 31, cooperating surfaces may be formed on gimbals portion 45 and frame portion 43.

The magnet drive for the magnets comprise four air coils (not shown), each wound on a bobbin in turn mounted on mounting bracket and aligned with respective recesses and magnets 53. The bobbin and bracket are made of suitable material for good heat transfer, magnetic dampening, and strength such as aluminum. The coils are wound using high electrical conductivity materials such as copper. The bobbin has an coil disposed proximate to top end of the bobbin such that the coil is as close to magnets 53 as possible, for example, 200 microns, to provide full mirror rotation using minimum power.

Although the arrangement and operation of the movable mirror has been described with regards to specific embodiments thereof, variations and modifications will become apparent to those skilled in the art. For example, magnet and air coil locations other than those described above can be employed as long as appropriate currents can be applied to the air coils to move the gimbaled mirror to a desired orientation. The two coils associated with movement along an axis can of course operate independently. Further, it may also be desirable to provide rotation from a neutral position in only one direction.

In addition, it may be sufficient that the mirror rotate only about a single axis. Such an arrangement could of course use the two-axis mirror arrangement shown in FIG. 5, by not providing (or not activation) drive coils for one of the axis.

An additional feature related to the control of the mirror is the angle feedback sensor (not shown). This feature uses a surface emitting light emitting diode (LED) positioned centrally between 4 detectors located behind the mirror. As the angle of the mirror changes, the intensity of LED light reflecting off the back of the mirror to each of the detectors changes, producing a larger response in one or more detectors and smaller response in the others. By measuring the detector signals, an estimation of the instantaneous mirror angle can be constructed. This technique is detailed in co-pending patent application Ser. No. 09/957,476 (TI-31612), filed Sep. 20, 2001 and incorporated herein by reference. The ability to measure the instantaneous angle is advantageous in being able to switch the mirror rapidly between positions using closed loop control algorithms.

Returning to FIG. 4, in its simplest fashion, analog mirror device 424 either directs the received light back into GRIN lens 422 or to GRIN lens 426. GRIN lens 426 directs light signals to and from the add-drop ports. As shown in FIG. 4, a bi-directional tap 428 can be included in the path between lens device 426 and optical multiplexer/demultiplexer 430. Add and drop detectors 432 and 434 receive the tapped signals from tap 428. Circulator 436 provides the added signals to multiplexer/demultiplexer 430 and receives dropped signals from the multiplexer/demultiplexer 430. The operation of the add/drop portion of OADM 400 is similar that of the in/out portion of the system and therefore will not be described separately.

In addition to being able to adjust the amount of light coupled between fibers, using analog mirrors rather than digital mirrors has the potential advantage that a digital mirror requires precise alignment in position and angle of the GRIN lenses to the digital mirrors, while only position is important for an analog mirror. Differences in angle can be accommodated by the analog mirrors ability to address all angles rather than just two. This advantage simplifies the switch manufacturing process.

In the preferred embodiment, the add/drop channels are WDM channels. In an alternate embodiment, the add/drop channels could be single wavelength channels. In that case, the multiplexer/demultiplexer 430 would not be needed.

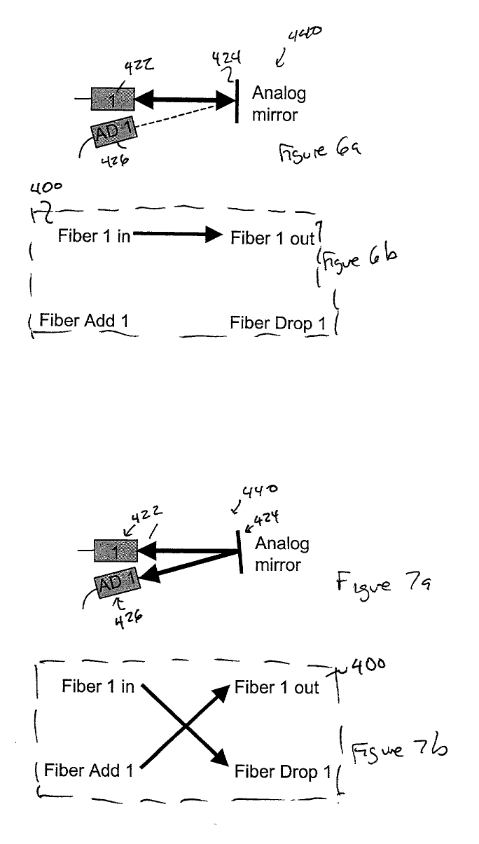

Fault tolerance could still be added to this system by adding 1×2 switches (not shown) at Fiber In and Fiber Out, such that Fiber In is connected to one of two possible input fibers and Fiber Out is connected to one of two possible output fibers In case of a break in the default input or output fibers somewhere in the network, the 1×2 switches could be changed to use the auxiliary input and/or output fibers. FIGS. 6a-6b and 7a-7b provide information on the operation of the switch optics 440. FIGS. 6a and 6b illustrate the operation of switch optics 440 in the pass through state. In this state, light from lens device 422 is directed to analog mirror device 424 and retransmitted through the lens device 422. As shown in FIG. 4, this light will be returned to multiplexer/demultiplexer 410 for recombination into the WDM signal at output port 408.

FIGS. 7a and 7b illustrate operation of switch optics 440 in the add/drop state. In this state, light from lens device 422 is directed to analog mirror device 424 and redirected to lens device 426. From lens 426, the light will be provided to the drop port 442, through multiplexer/demultiplexer 430 and circulator 436. Similarly, light from the add port 444 is directed through lens device 426 toward the analog mirror device 424 where it is reflected into lens device 422. This added signal could then be combined into the WDM signal by multiplexer/demultiplexer 410.

Using analog mirror device 424 can provide a number of advantages over other methods. Examples that utilize the increased functionality of an analog mirror device will now be described.

As an example, variable attenuation can be achieved by slightly misaligning the analog mirror 424 with respect to the lens device 422 (or 424). When the analog mirror 424 is perfectly aligned with the lens device 422 (or 424), a maximum amount of optical power will be transmitted through the lens device 422 (or 424). As the alignment is varied, the lens will not capture some of the optical signal and as a result the power will be attenuated.

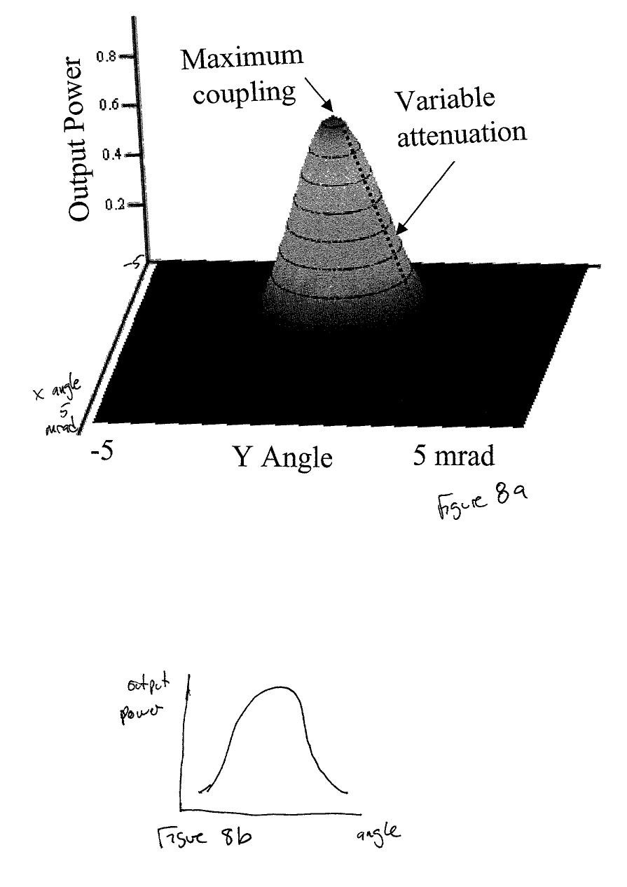

FIGS. 8a and 8b are provided to illustrate the relationship between the output power and the mirror angle for two embodiments. In the embodiment of FIG. 8a, a mirror that can rotate around two independent axes is shown. As seen, a relatively small tilt in the angle can result in substantial variations in the output power. In the example illustrated, variations of +/−5 mrad (milli-radians) in either axis or both can result in output coupling going from maximum to zero.

FIG. 8b shows a similar relationship for an analog mirror that rotates along only one axis. (The same curve could be achieved by holding one on the axes constant with a mirror as discussed with respect to FIG. 8a.) Once again, the output power will vary as the mirror is tilted out of alignment.

The spectral power monitor function is built into the embodiment of Figure by use of the input detector 418, output detector 420, add detector 444, drop detector 442, and control circuit 438. The output power can be controlled by monitoring the output power with output detector 420 and adjusting the angle of the mirror through a control loop to raise, lower or maintain the output power as required. By instantaneously monitoring either the input power using the input detector 418 or the add power using add detector 444, changes in output power relating to variation in input or add light intensity can be differentiated from changes in output power due to analog mirror alignment. This is can be useful in design of the feedback control algorithms for instantaneously positioning the analog mirror.

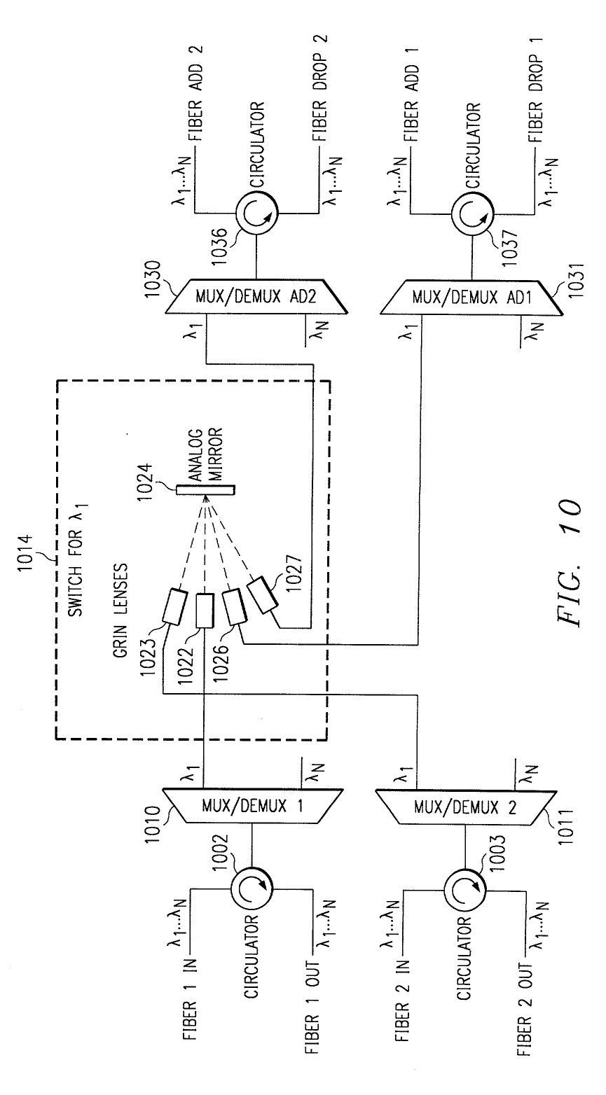

This power control process is illustrated in FIGS. 12a and 12b. FIG. 12a shows the input optical power and an arbitrary desired output optical power vs time. FIG. 12b then shows qualitatively the amount of analog misalignment (alignment offset in the graph, the top of the graph being worse alignment and therefore more loss) needed to produce the desired output optical power. For example as the input optical power decreases initially, the analog mirror misalignment is reduced to maintain the desired output level. When the input signal subsequently increases, the misalignment must also increase to maintain desired optical power. On the right hand side of the graph when a step increase in output optical power is desired, the analog mirror misalignment must be reduced to produce the higher optical power. Such feedback control algorithms are preferably implemented using digital control systems in a digital signal processor or microprocessor and are well known in the art.

In the system of FIG. 4, it is noted that both add and drop channels are attenuated simultaneously when the switch is configured to add and drop channels. This means that the fiber In to fiber Drop channel (port 404 to port 442) will be attenuated the same amount as the fiber Add to fiber Out channel (port 444 to port 408). If the intensity of the wavelength at fiber In port 404 is low (for example attenuated after traveling a long distance), further attenuation may be undesirable as it may make the signal difficult to detect. This problem could be eliminated by adding a fiber amplifier, e.g., an Erbium-doped fiber ASE (amplified spontaneous emission) source or an EDFA) at the fiber input port 404 to boost all incoming wavelength intensities.

The power monitor function could also be included on the wavelength specific side of multiplexer/demultiplexer if a directional tap is used.

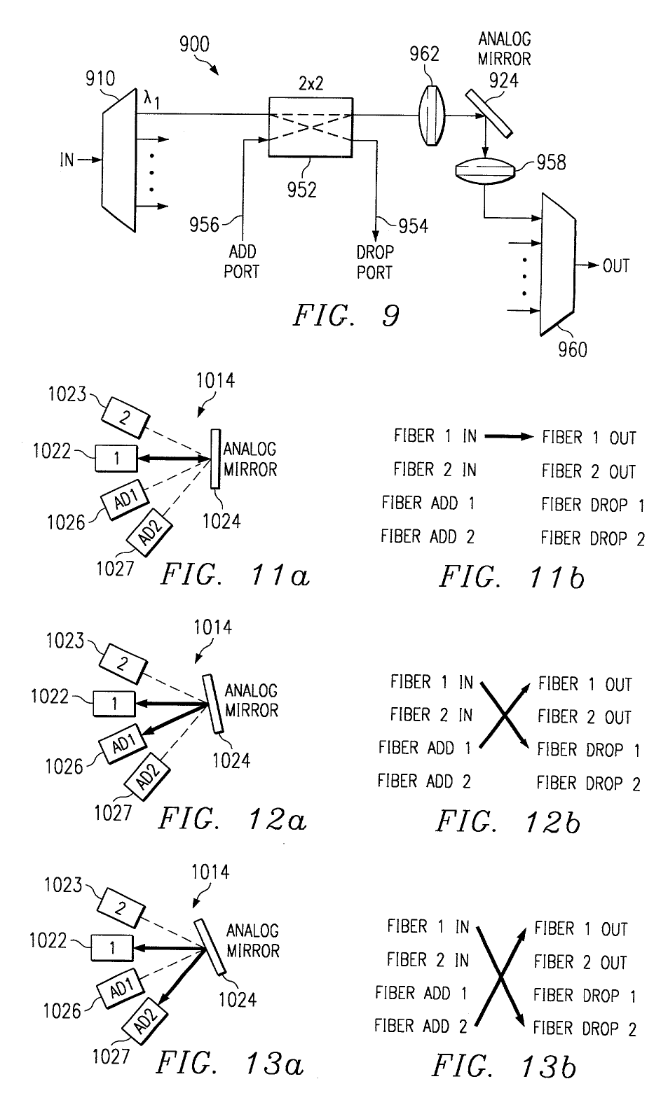

FIG. 9 shows an alternate embodiment OADM 900 which could utilize the attenuation features of the present invention. In OADM 900, a demultiplexer 910 receives a WDM signal at an input port and provides a number of output signals corresponding to the different wavelengths of each of the channels. As before, only a first wavelength signal λ₁ will be described.

The first wavelength signal λ₁ is provided to a 2×2 switch 952 where it is either passed through or switched to drop port 954. If first wavelength signal λ₁ is switched to drop port 954 another signal at wavelength λ₁ can be added from add port 956. Whichever signal is passed through will be directed toward analog mirror device 924 through lens 962. Optical elements, not shown, could be included between optical switch 952 and analog mirror 924.

Light from analog mirror 924 is directed to lens device 958, preferably a GRIN lens. Misaligning the mirror 924 and the lens 958, as discussed above, can variably attenuate this light. This configuration provides an alternate embodiment for the OVA 208 described above with respect to FIG. 2.

Light from lens 958 is provided to optical multiplexer 960 where it is combined with signals carried at other wavelengths to generate an output WDM signal.

FIG. 10 illustrates another embodiment OADM system 1000, which includes the ability to add, drop and switch between multiple fibers. In the specific embodiment of FIG. 10, it is assumed either Fiber 1 in/out or Fiber 2 in/out are used, but not both. The ability to switch between Fiber 1 in/out and Fiber 2 in/out provides fault tolerance. Multiple Add/Drop paths are also possible. Two are described but more can be added similarly.

The first fiber is input to first circulator 1002, which provides the WDM signal to multiplexer/demultiplexer 1010. Similarly, a second first is input to second circulator 1003, which provides the WDM signal to multiplexer/demultiplexer 1011. As before, only a first wavelength λ₁ channel will be described.

The first wavelength λ₁ channel from the first multiplexer/demultiplexer is provided to bi-directional lens device 1022 and the first wavelength λ₁ channel from the second multiplexer/demultiplexer is provided to bi-directional lens device 1023. Lens devices 1022 and 1023 are preferably GRIN lenses. Each of the lens devices 1022 and 1023 are directed toward the center of rotation of analog mirror device 1024. In the illustrated example, analog mirror device 1024 can redirect the light toward either the first fiber, the second fiber or one of two add/drop fibers.

One of the advantages of using the present invention is that it provides a great deal of flexibility in switching between fibers. For example, FIG. 10 shows a case that includes two input/output fibers and two add/drop fibers. In another case, the device could have a single input/output fiber and multiple add/drop fibers or multiple input/output fibers and a single add/drop fiber. The only real limitation is based on the number of lens that can be accurately aligned with the analog mirror, which can be increased by moving the GRIN lenses farther from the analog mirror allow more space for the GRIN lenses within the addressable angles of the analog mirror, at the expense of increasing coupling loss between GRIN lenses. Of course, since the light coming out of the GRIN lens is not perfectly collimated—fundamental physics limitation—as the path length between any two increases the loss of light will be higher. Using the mirror technology described above a single mirror could easily work with ten or more lenses.

FIGS. 11a-b to 16a-b illustrate six possible switch modes for each wavelength. Although in the diagrams the GRIN lenses 1022-1027 are shown in plane, a 2-axis analog mirror would allow placement of the GRIN lenses 3-dimensionally. The only preference is that the GRIN lens is aligned to the center of the analog mirror 1024.

One advantage to being able to use one mirror per wavelength or channel is that light flows bi-directionally through the switch 1014 and the fiber add does not connect to fiber drop when fiber in connects to fiber out.

FIGS. 11a-11b, 12a-12b and 13a-13b illustrate the case when Fiber 1 is active. In this case, wavelengths λ₁-λ_{N} enter the device at the Fiber 1 in port, pass through circulator 1002 and are separated in multiplexer/demultiplexer 1010. Each wavelength goes to lens device 1022 in a separate switch (only one of which is illustrated).

For each wavelength, one of the following three modes is selectable. The mode for each wavelength in the device is selected independently of any other channels in the OADM 1000.

FIGS. 11a and 11b illustrate a first mode, where a signal is input in fiber 1 and output to the same port. In this case, the signal exits lens device 1022 and is directed to analog mirror 1024. The analog mirror is normal to lens 1022 and therefore reflects the signal back into lens 1022, where it returns to multiplexer/demultiplexer 1010. From multiplexer/demultiplexer 1010, the signal passes back through circulator 1002 to the Fiber 1 out port. As a result, the first wavelength signal goes from the Fiber in port to the Fiber 1 out port.

FIGS. 12a and 12b illustrate a second mode where the first wavelength signal goes from the Fiber 1 in port to the Fiber Drop 1 port and from the Fiber Add 1 port to the Fiber 1 out port. In this case, the first wavelength signal exits lens device 1022 and is directed to analog mirror 1024. Analog mirror 1024 is oriented such that the image of lens device 1026 is aligned to lens device 1022, thereby reflecting the signal into lens 1026 where it passes through multiplexer/demultiplexer 1031, through circulator 1037, and out to the Fiber Drop 1 port. Similarly, a signal from Fiber Add 1 port is separated in multiplexer/demultiplexer 1031, goes through lens device 1026, reflects into lens device 1022 and goes to multiplexer/demultiplexer 1010. Passing back through circulator 1002, the signal goes to the Fiber 1 out port.

FIGS. 13a and 13b illustrate a third mode where the signal goes from the Fiber 1 in port to the Fiber Drop 2 port and from the Fiber Add 2 port to the Fiber 1 out port. In this mode, the single wavelength signal exits lens device 1022 and is directed to analog mirror 1024. The analog mirror 1024 is oriented such that the image of lens 1027 is aligned to lens device 1022 so that the optical signal is reflected from the mirror 1024 into lens device 1027. The signal then travels to multiplexer/demultiplexer 1030 where it passes through circulator 1036 and goes to the Fiber Drop 2 port. Similarly, a signal from the Fiber Add 2 port is separated in multiplexer/demultiplexer 1030, goes through lens device 1028, is reflected into lens device 1022 and goes to multiplexer/demultiplexer 1010. Passing back through circulator 1002, the signal goes to the Fiber 1 out port.

In FIGS. 14a-14b, 15a-15b, and 16a-16b, the Fiber 2 ports are active. In these circumstances signals at wavelengths λ₁-λ_{N} come enter at the Fiber 2 in port, pass through circulator 1003 and are separated in multiplexer/demultiplexer 1011. Each wavelength signal goes to a lens device 1023 in a separate switch 1014 (only one of which is shown). Three modes similar to those described above will now be discussed.

FIGS. 14a and 14b show a fourth mode where a signal is passed through from the Fiber 1 in port to the Fiber 2 out port. In this mode, the signal exits lens device 1023 and is directed to analog mirror device 1024. Analog mirror 1024 is normal to lens device 1023 so that the signal is reflected back into the lens device 1023, to multiplexer/demultiplexer 1011. Passing back through circulator 1003, the signal goes to the Fiber 2 out port.

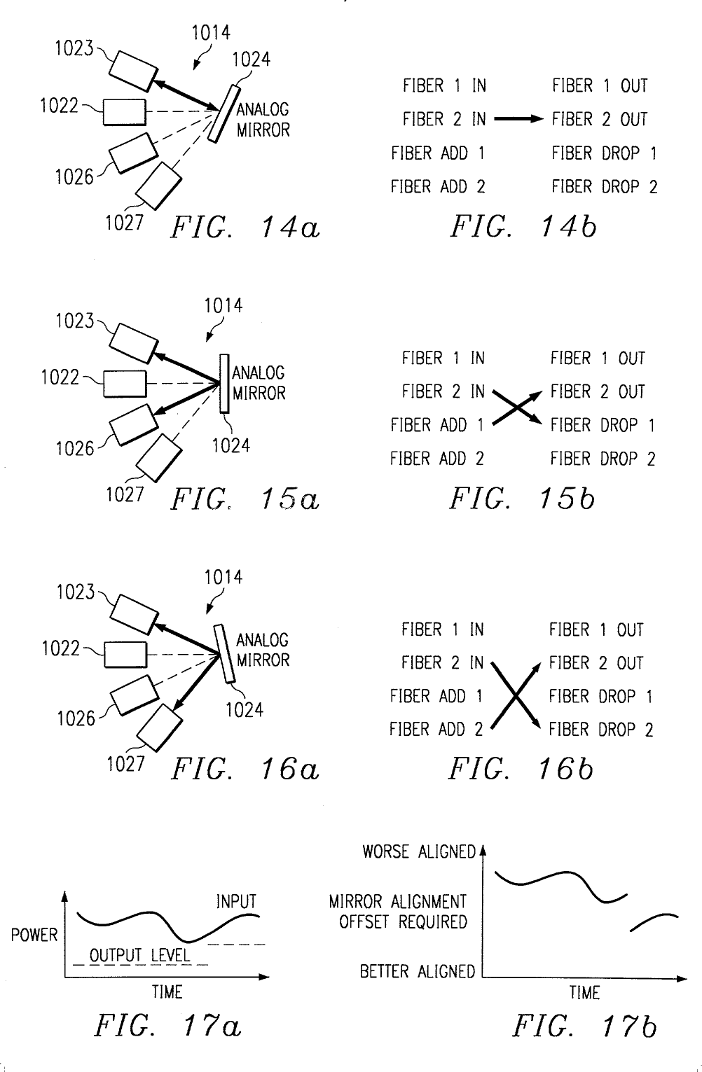

FIGS. 15a and 15b shows fifth mode where the signal passed from the Fiber 2 in port to the Fiber Drop 1 port and from the Fiber Add 1 port to the Fiber 2 out port. In this mode, the signal exits lens device 1023 and is directed to analog mirror 1024. Analog mirror 1024 is oriented such that the image of lens device 1026 is aligned to lens device 1023 thereby reflecting the signal into lens device 1026 and from there to multiplexer/demultiplexer 1031. Passing through circulator 1037, the signal goes to the Fiber Drop 1 port. Similarly, the signal from the Fiber Add 1 port is separated in multiplexer/demultiplexer 1031 and goes through lens device 1026, reflects from mirror 1024 into lens device 1023 and goes to multiplexer/demultiplexer 1011. Passing back through circulator 1003, the signal goes to the Fiber 2 out port.

FIGS. 16a and 16b shows sixth mode where the signal passed from the Fiber 2 in port to the Fiber Drop 2 port and from the Fiber Add 2 port to the Fiber 2 out port. In this mode, the signal exits lens device 1023 and is directed to analog mirror 1024. Analog mirror 1024 is oriented such that the image of lens device 1027 is aligned to lens device 1023 thereby reflecting the signal into lens device 1027 and from there to multiplexer/demultiplexer 1030. Passing through circulator 1036, the signal goes to the Fiber Drop 2 port. Similarly, the signal from the Fiber Add 2 port is separated in multiplexer/demultiplexer 1030 and goes through lens device 1027, reflects from mirror 1024 into lens device 1023 and goes to multiplexer/demultiplexer 1011. Passing back through circulator 1003, the signal goes to the Fiber 2 out port.

While six modes have been described it is understood that other transfers are possible. For example, a first wavelength signal traveling on Fiber 1 can be transferred to Fiber 2 while the same wavelength from Fiber 2 is transferred to Fiber 1. This embodiment could be useful in telecommunications applications.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An optical add-drop multiplex device comprising:
an optical demultiplexer having an input port coupled to receive an input optical signal carrying information at a plurality of wavelengths, the optical demultiplexer having a plurality of outputs, each output for carrying an optical signal at one of the plurality of wavelengths; and
switch optics including a channel coupled to each output, each channel of the switch optics including:
an analog mirror device coupled to receive the optical signal for that channel, the analog mirror being rotatable along at least one axis and able to reflect a received optical signal in more than two directions;
an in/out lens device aligned to receive the optical signal from the analog mirror device when said analog mirror device is in a pass mode; and
an add/drop lens device aligned to receive said optical signal from the analog mirror device when said analog mirror device is in an add/drop mode.

2. The device of claim 1 and further comprising a circulator having an output providing the input optical signal to the input of the optical demultiplexer.

3. The device of claim 2 wherein the optical demultiplexer comprises a bi-directional multiplexer/demultiplexer.

4. The device of claim 3 and further comprising a bi-directional tap coupled between each output of the optical demultiplexer and an associated channel of the switch optics.

5. The device of claim 1 wherein the in/out lens comprises a GRIN lens and wherein the add/drop lens comprises a GRIN lens.

6. The device of claim 1 and further comprising:
an add/drop multiplexer/demultiplexer coupled to receive optical signals from the add/drop lens of channels of the switch optics; and
an add/drop circulator with a second port coupled to a multiplexed input/output of the add/drop multiplexer/demultiplexer.

7. The device of claim 1 wherein each channel of the switch optics further includes a third device aligned to receive the optical signal from the analog mirror device when the analog mirror is in a third mode.

8. The device of claim 7 wherein each channel of the switch optics further includes a fourth lens device aligned to receive the optical signal from the analog mirror device when the analog mirror is in a fourth mode.

9. The device of claim 8 wherein the third lens device comprises an in/out lens device and the fourth lens device comprises an add/drop lens device.

10. The device of claim 1 wherein the analog mirror is controllable to that the attenuation of a signal passing through the in/out lens can be varied by varying the alignment between the in/out lens and the analog mirror.

11. The device of claim 10 further comprising:
a tap coupled between each output of the optical demultiplexer and an associated channel of the switch optics; and
an optical power detector coupled to received a tapped optical signal from the tap.

12. The device of claim 11 wherein the tap comprises a bi-directional tap.

13. The device of claim 11 wherein the optical power detector is coupled to the analog mirror device so as to control the tilt of the analog mirror device based on the intensity of the tapped optical signal.

14. An optical attenuation device comprising:
an analog mirror device aligned to receive an optical signal;
a lens device aligned to receive a reflected version of the optical signal; and
a control circuit coupled to the analog mirror device, the control circuit causing the analog mirror device to change an alignment relative to the lens device, the change in alignment corresponding to a change in attenuation of the optical signal passed through the lens device.

15. The device of claim 14 and further comprising a second lens device, the analog mirror controllable to reflect the optical signal to either the lens device or the second lens device.

16. The device of claim 14 wherein the analog mirror device includes a mirror surface that can rotate along two axes.

17. The device of claim 14 wherein the analog mirror receives the optical signal from an optical 2×2 switch.

18. The device of claim 14 wherein the analog mirror receives the optical signal from the lens device.

19. A method of processing an optical signal, the method comprising:
receiving an optical signal at a particular wavelength;
directing the optical signal toward an analog mirror device;
reflecting the optical signal from the analog mirror device into a lens device, the reflecting being controlled in a manner that affects the attenuation of an optical signal transmitted through the lens.

20. The method of claim 19 and further comprising:
receiving a wavelength division multiplexed signal, wherein the optical signal is demultiplexed from the wavelength division multiplexed signal; and
combining the optical signal transmitted through the lens with other optical signals to create a second wavelength division multiplexed signal.

21. The method of claim 19 wherein the optical signal is directed toward the analog mirror device from the lens device.

22. The method of claim 19 wherein the reflecting is controlled by controlling the tilt of mirror of the analog mirror device.

23. The method of claim 22 wherein the tilt is controlled along one axis of the analog mirror device.

24. The method of claim 22 wherein the tilt is controlled along two axes of the analog mirror device.

25. The method of claim 19 and further comprising measuring a characteristic of the optical signal that is transmitted through the lens, the reflecting being controlled based on the measuring.

26. The method of claim 24 wherein measuring a characteristic comprises measuring optical power.
